(19) United States
(12) Patent Application Publication
(10) Pub. No.: US 2004/0149232 A1
(43) Pub. Date: Aug. 5, 2004

(54) Litter box sytem

(76) Inventor: Stephen N. Griffin, Atlanta, GA (US)

Correspondence Address: DESIGN IP, 5000 W. TILGHMAN STREET, SUITE 153, ALLENTOWN, PA, 18104, US

(21) Appl. No.: 10/752,404

(22) Filed: Jan. 6, 2004

Related U.S. Application Data
(60) Provisional application No. 60/438,272, filed on Jan. 6, 2003.

(51) Int. Cl. A01K 29/00

(52) U.S. Cl. 119/165

(57) ABSTRACT

A litter box system comprising an open-top container and an enclosure that defines a chamber, an exterior, an entrance, and a first opening located between the entrance and the chamber. The enclosure includes a housing and a door having a first position and a second position. The container and chamber are shaped so that the container may be placed in the chamber in an upright position and the entrance allows access to the container when the container is located in the chamber. The first opening is larger when the door is in the second position than when the door is in the first position, so that the container can be removed from the chamber in the upright position.

### BACKGROUND OF THE INVENTION

The invention relates generally to a sanitary container and enclosure for a cat, commonly called a “litter box.” The simplest of conventional litter boxes consist of a container designed to contain cat litter. Such litter boxes usually have an open top, which allows odors to waft throughout the room in which the litter box is located and results in the cat litter being visible to people in the room. In addition, cats tend to track litter from the litter box into the room when the cat exits the litter box. These deficiencies are of particular concern when the litter box is used in a small living environment, such as a small house or apartment, where it is not possible to place the litter box in a basement or in a room not regularly used by people.

In order to reduce these deficiencies, there have been attempts to provide enclosed litter boxes. Some such attempts have failed to address all of the deficiencies discussed above. Other attempts have resulted in apparatuses that are complex and/or difficult to clean.

Accordingly, there is a need for a litter box system that is simple to manufacture, easy to clean, and that addresses the needs of cat owners who reside in small living environments.

### BRIEF DESCRIPTION OF THE DRAWINGS

The present invention will hereinafter be described in conjunction with the appended drawing figures wherein like numerals denote like elements.

FIG. 1 is an expanded perspective view of one embodiment of the litter box system of the present invention.

FIG. 2 is a perspective view of the litter box system, assembled, with the door in an open position and in a left-handed orientation.

FIG. 3 is a perspective view of the litter box system, assembled, with the door in a closed position and in a left-handed orientation.

FIG. 4 is a perspective view of the litter box system, assembled, with the door in an open position and in a right-handed orientation.

FIG. 5 is a perspective view of the litter box system, shown with the container resting in a recess on the top surface of the housing.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

In order to provide context for features of the invention, reference numerals introduced in the specification in association with a drawing figure may be repeated in one or more additional figures without a specific reference in the specification to that reference numeral in the additional figures.

Directional terms, including “top,” “bottom,” “upper,” “lower,” etc., are used in the specification and claims to simplify explanation of the relative location of elements of the invention and refer to their orientation in the drawings. Such directional terms are not intended to limit the scope of the invention in any way.

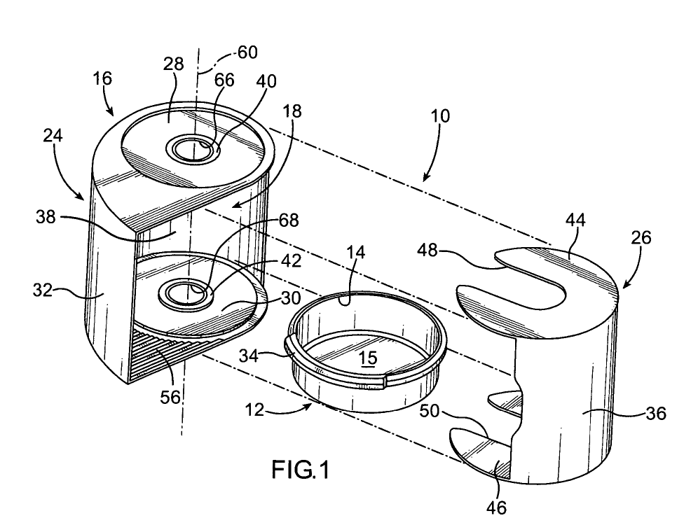

Referring now to FIG. 1 a first embodiment of a litter box system 10 is shown. The litter box system 10 comprises a container 12 that is used to hold cat litter (not shown) and an enclosure 16 which is designed to shield the container 12 from view, but allow for easy access to the container 12.

In this embodiment, the litter box system 10 is made of a rigid polymer, such as polyethylene or polypropylene. Rigid polymers are preferred because they provide a desirable combination of durability, stain and odor resistance, ease of manufacture, low cost and relatively low weight. However, any other suitable material could be used.

In this embodiment, the container 12 is generally cylindrical in shape and includes an open top 14 and a circular base 15. The container 12 should be of sufficient volume to allow a reasonable volume of cat litter to be placed therein and of sufficient diameter to allow a cat to use the container comfortably. A container 12 that is 4-6 inches deep and 12-18 inches in diameter has been found to be suitable.

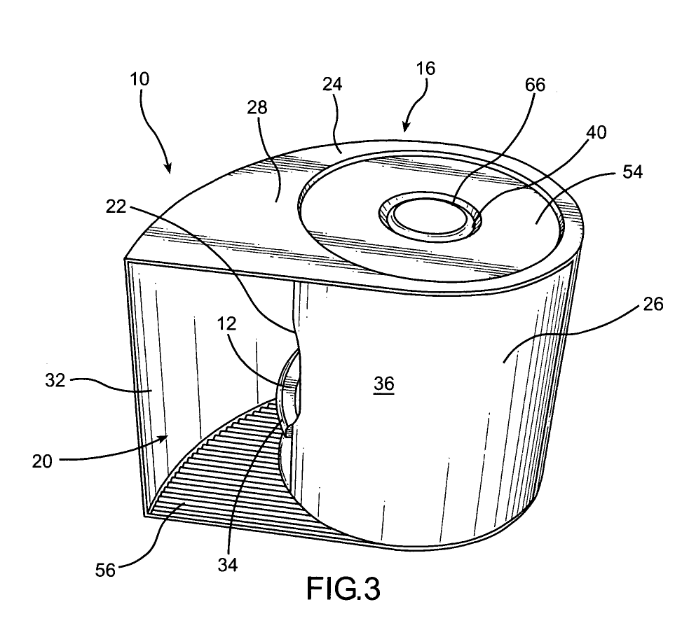

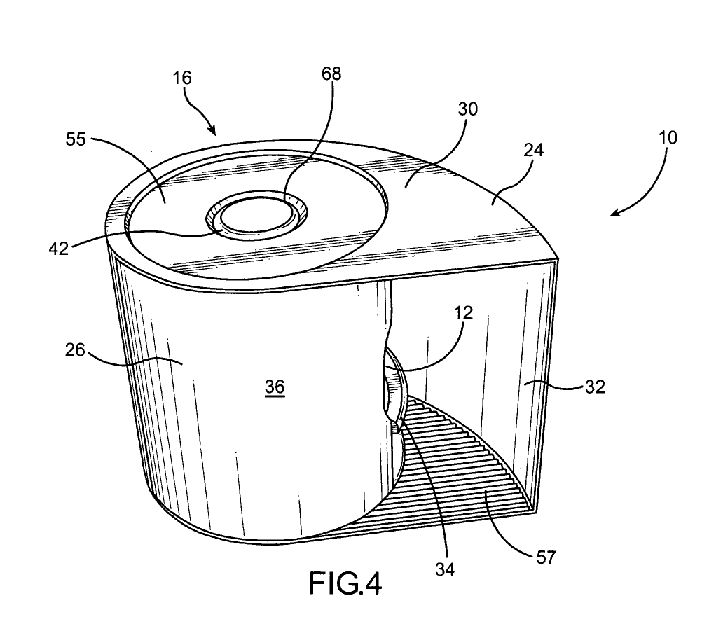

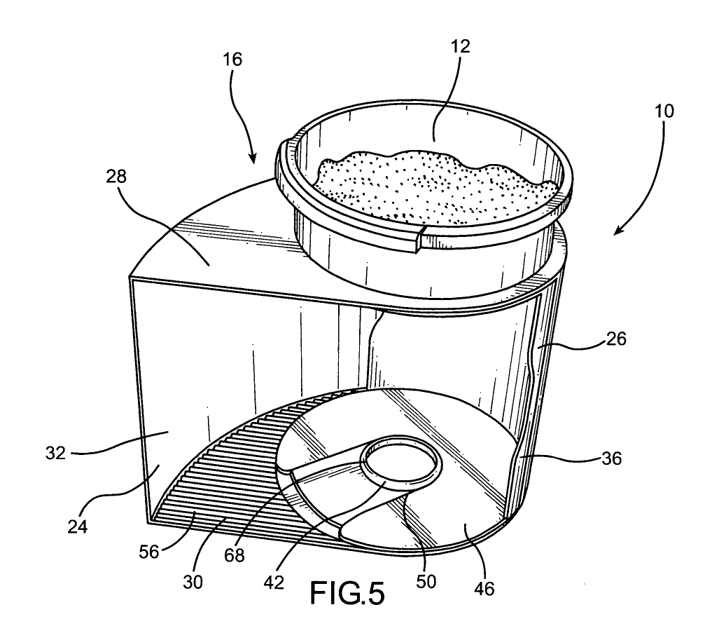

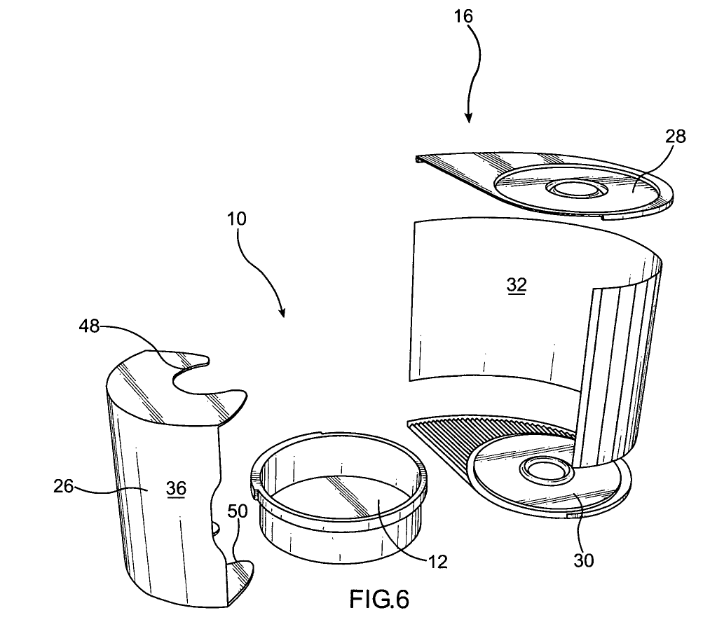

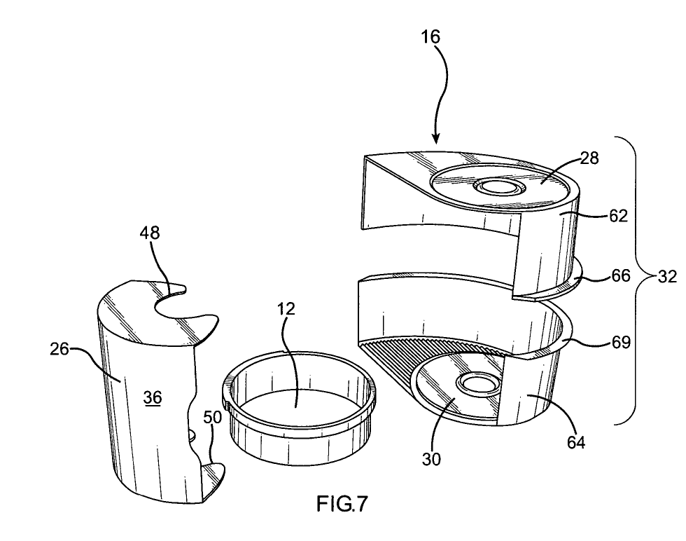

The enclosure 16 includes two primary parts: a housing 24 and a door 26. The housing 24 and door 26 are both preferably horizontally symmetrical so that the enclosure 14 can be used in a left-handed orientation (see FIG. 3) or a right-handed orientation (see FIG. 4). This allows the system 10 to be accommodated in a wider variety of spaces.

The housing 24 includes generally planar top and bottom surfaces 28, 30 which are joined by a vertical wall 32. As will be described in greater detail herein, the door 26 and housing 24 define a chamber 18 in which the container 12 is placed. In this embodiment, the chamber 18 is cylindrical in shape.

Circular openings 66, 68 are preferably provided in the top and bottom surfaces 28, 30, respectively. The openings 66, 68 are centered about a vertical axis 60 and are parallel. The openings 66, 68 are provided to allow light to enter the chamber 18, to enhance air circulation and to serve as means to carry the litter box system 10. The opening 66 in the top surface 28 would perform this function when the enclosure 14 is in the left-handed orientation and the opening 68 in the bottom surface 30 performs this function when the enclosure 14 is in the right-handed orientation. A ridge 40, 42 is formed along the perimeter of each respective opening 66, 68. The ridges 40, 42 extend inwardly toward the chamber 18 and, as will be described in greater detail below, are used to engage the door 26.

The door 26 includes generally planar upper and lower surfaces 44, 46 which are joined by a vertical wall 36. The upper and lower surfaces 44, 46 are designed to pivotally engage the door 26 with the enclosure 16 and the wall 36 is designed to shield the container 12 from view (see FIG. 3). The upper and lower surfaces 44, 46 each include a U-shaped slot 48, 50. The upper slot 48 engages the ridge 40 located on the top surface 28 and the lower slot 50 engages the ridge 42 located on the bottom surface 30. This enables the door 26 to be rotated about the vertical axis 60. In this embodiment, the wall 36 of the door 26 follows a circumferential path when the slots 48, 50 are engaged with the ridges 40, 42 and the door 26 is rotated about the vertical axis 60.

The open shape of the slots 48, 50 allow the door 26 to be easily removed for cleaning. Alternatively, the slots 48, 50 could be replaced with circular openings (not shown) that are of the same shape, but slightly larger in size than the ridges 40. This would provide a more secure connection between the door 26 and the housing 24. However, engaging and removing the door 26 from the housing 24 would require the upper and lower surfaces 44, 46 to be bend inwardly (away from the ridges 40, 42).

The container 12 preferably includes a lip 34 which constrains rotation of the door 26. When the slots 48, 50 of the door 26 are engaged with the ridges 40, 42, the door 26 is rotated so that the wall 36 abuts the lip 34 and the container 12 is rotated so that the lip 34 also abuts the wall 32 of the housing 24, the door 26 is in what will be referred to as a closed position (see FIG. 3). In the closed position, most of the container 12 is shielded from view. In this embodiment, only a small portion of the container 12 is visible. In the closed position, the wall 36 of the door 26 and the wall 32, top surface 28 and bottom surface 30 of the housing 24 define an entrance area 20 to the chamber 18. In this embodiment, the entrance area 20 narrows to an opening 22, which defines the transition from the entrance area 20 to the chamber 18. This opening 22 has a width W defined as the distance from the wall 32 of the housing 24 to the wall 36 of the door 26. This width W is at a minimum when the door 26 is in the closed position.

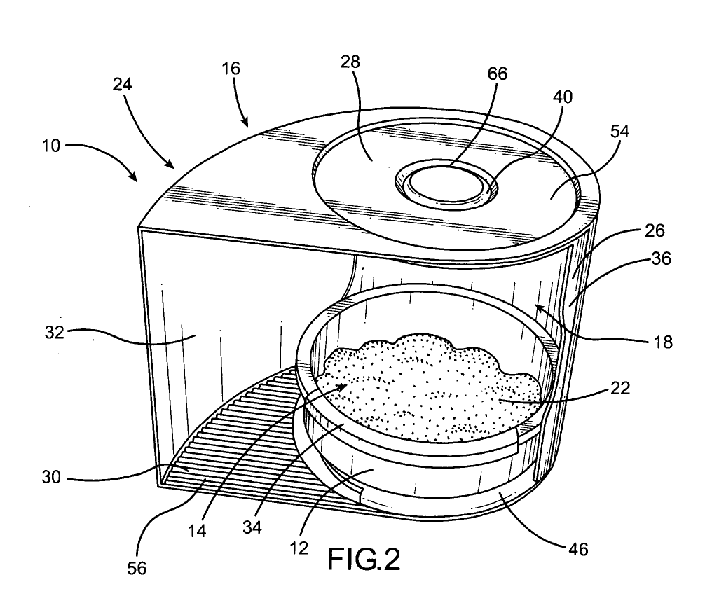

In order to access the container 12 and/or remove it for cleaning, the door 26 is rotated into an open position (see FIG. 2). In the open position, the opening 22 is much larger than when the door 26 is in the closed position. The wall 36 of the door 26 is preferably similar in shape to a portion 38 (see FIG. 1) of the wall 32 that borders the chamber 18. This allows the door 26 to nest inside the wall 32 when the door 26 is rotated into the open position (see FIG. 2). Optionally, a stop (not shown) could be included on the housing 26 to prevent the wall 36 of the door 26 from rotating completely inside the housing 12.

The container 12, the chamber 18 and the wall 36 of the door 26 are preferably shaped so that the container 12 can be placed in the chamber 18 in an upright position (i.e., with the top surface 14 facing upwardly, as shown in FIG. 2) and can be inserted into and removed from the chamber 18 in the upright position. This embodiment of the litter box system 10 accomplishes this through a cylindrical structure. Alternative shapes could also be used.

In order to reduce tracking of cat litter from the container 12 to the room in which the litter box system 10 is used, a ribbed surface 56 (see FIGS. 2 & 3) is provided on the bottom surface 30 of the housing 24 in the entrance area 20. A second ribbed surface 57 (see FIG. 4) is provided on the top surface 28 in the entrance area 20 to reduce tracking when the enclosure 14 is in the right-handed orientation. Other tactile and/or textured surfaces could also be used.

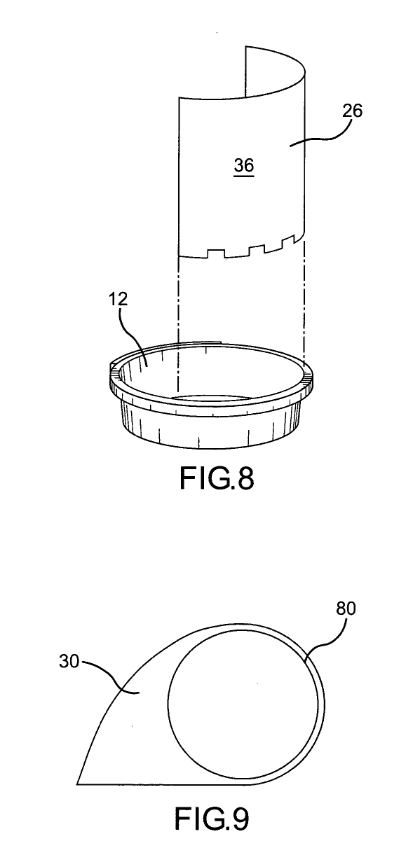

Optionally, a recessed area 54 could be included on the top surface 28 (see FIGS. 2 & 3), to provide a convenient location to set the container 12 when cleaning the litter contained therein (see FIG. 5). The recessed area 54 is preferably shaped to receive the base 15 of the container 12. In order to provide the same functionality when the enclosure 14 is in the right-handed orientation, a similar recessed area 55 (see FIG. 4) is located on the bottom surface 30.

Two alternative embodiments of the invention are shown in FIGS. 6 & 7. In FIG. 6, the top surface 28, bottom surface 30 and wall 32 of the housing 24 are each separate parts. In FIG. 7, the housing 24 is constructed of two separate halves: a top half 62 and a bottom half 64. The top half 62 consists of the top surface 28 and a portion of the wall 32. The bottom half 64 consists of the bottom surface 30 and a portion of the wall 32. Means are preferably provided to secure the top half 62 to the bottom half 64, such as interlocking flanges 66, 69, as shown in FIG. 7. In both FIGS. 6 & 7, the upper and lower surfaces 44, 46 of the door 26 are shorter than in the embodiment of the litter box system 10 shown in FIGS. 1-5. This makes the door 26 lighter, less prone to breakage and easier to remove from the housing 24, but provides a smaller engaging surface between the slots 48, 50 and the ridges 40, 42.

FIG. 8 shows another alternative embodiment of the litter box system 10 in which the door 26 consists of a curved wall 36 that engages (i.e., is attached, either permanently or removably) the container 12. Alternatively, the door 26 could consist of a curved wall 36 that extends from the top surface 28 to the bottom surface 30 (as in FIGS. 1-7) rotates in channels or tracks formed in the top and bottom surfaces 28, 30. The location of such a channel 80 in the bottom surface 30 is shown in FIG. 9. A corresponding channel would be included in the top surface 28. Such channels or tracks could also be used in combination with the embodiment of the door 26 shown in FIG. 8.

While the principles of the invention have been described above in connection with preferred embodiments, it is to be clearly understood that this description is made only by way of example and not as a limitation of the scope of the invention.

1. An apparatus comprising:
a container having an open top and an upright position in which the open top is oriented upwardly; and
an enclosure that defines a chamber, an exterior, an entrance, and a first opening located between the entrance and the chamber, the enclosure including a housing and a door having a first position and a second position;
wherein the container and chamber are shaped so that the container may be placed in the chamber in the upright position, and the entrance allows access to the container when the container is located in the chamber; and
wherein the first opening is larger when the door is in the second position than when the door is in the first position, and the container can be removed from the chamber in the upright position.

2. The apparatus of claim 1, wherein more than half of the open top is shielded from the exterior when the door is in the first position.

3. The apparatus of claim 1, wherein the door is removable from the housing.

4. The apparatus of claim 1, wherein the door pivots about an axis.

5. The apparatus of claim 4, wherein the door includes a wall that follows a circumferential path when the door is pivoted about the axis.

6. The apparatus of claim 1, wherein the housing comprises a top surface, a bottom surface and a first wall.

7. The apparatus of claim 6, wherein the container includes a lip that prevents the door from rotating beyond a predetermined rotational position when the lip is positioned between the first wall and the door, thereby maintaining a minimum width of the entrance opening.

8. The apparatus of claim 6, wherein the door includes a second wall that is of the same shape as a portion of the first wall of the housing so that the second wall at least partially nests with the first wall when the door is rotated into the second position.

9. The apparatus of claim 6, wherein the top surface includes a first circular ridge centered on a vertical axis, the bottom surface including a second circular ridge centered on the vertical axis and parallel to the first circular ridge.

10. The apparatus of claim 9, wherein the door includes an upper surface and a lower surface, the second wall connecting the upper and lower surfaces, the upper surface including an upper slot and the lower surface including a lower slot, the upper and lower slots each being adapted to engage the upper and lower ridges, respectively, so that the door pivots about the vertical axis when the upper and lower slots are engaged with the upper and lower ridges.

11. The apparatus of claim 10, wherein the upper and lower slots are U-shaped.

12. The apparatus of claim 6, wherein the top surface includes a first channel that engages the door and the door moves along the first channel when moving from first position to the second position.

13. The apparatus of claim 12, wherein the bottom surface includes a second channel that engages the door and the door moves along the first channel when moving from first position to the second position.

14. The apparatus of claim 1, wherein the door engages the container.

15. The apparatus of claim 1, wherein the door is engages the housing.

16. The apparatus of claim 1, wherein the top surface includes a first recess shaped to receive a portion of the container therein when the enclosure is in a left-handed orientation.

17. The apparatus of claim 16, wherein the bottom surface includes a second recess shaped to receive a portion of the container therein when the enclosure is in a right-handed orientation.

18. The apparatus of claim 1, wherein the bottom surface includes a first textured surface located between the first opening and the exterior.

19. The apparatus of claim 18, wherein the top surface includes a second textured surface located between the first opening and the exterior.

20. The apparatus of claim 1, wherein the enclosure is horizontally symmetrical so that the enclosure can be used in a left-handed or right-handed orientation.

21. The apparatus of claim 1, wherein the enclosure includes a top portion and a bottom portion that is separable from the top portion.

22. An apparatus comprising:
a container having an open top and an upright position in which the open top is oriented upwardly; and
an enclosure that defines a chamber, an exterior, an entrance, and a first opening located between the entrance and the chamber, the enclosure including a housing and a door having a first position and a second position, the housing comprising a top surface, a bottom surface and a first wall, the top surface includes a first circular ridge centered on a vertical axis, the bottom surface including a second circular ridge centered on the vertical axis and parallel to the first circular ridge, the door including an upper surface and a lower surface, the second wall connecting the upper and lower surfaces, the upper surface including an upper slot and the lower surface including a lower slot, the upper and lower slots each being adapted to engage the upper and lower ridges, respectively, so that the door pivots about the vertical axis when the upper and lower slots are engaged with the upper and lower ridges.

23. An apparatus comprising:
a container having an open top and an upright position in which the open top is oriented upwardly; and
an enclosure that defines a chamber, an exterior, an entrance, and a first opening located between the entrance and the chamber, the enclosure including a housing and a door having a first position and a second position, the housing comprising a top surface, a bottom surface and a first wall, the top surface includes a first circular ridge centered on a vertical axis, the bottom surface including a second circular ridge centered on the vertical axis and parallel to the first circular ridge, the door including an upper surface and a lower surface, the second wall connecting the upper and lower surfaces, the upper surface including an upper slot and the lower surface including a lower slot, the upper and lower slots each being adapted to engage the upper and lower ridges, respectively, so that the door pivots about the vertical axis when the upper and lower slots are engaged with the upper and lower ridges
wherein the container and chamber are shaped so that the container may be placed in the chamber in the upright position, and the entrance allows access to the container when the container is located in the chamber; and
wherein the first opening is larger when the door is in the second position than when the door is in the first position, and the container can be removed from the chamber in the upright position.
